(19) United States
(12) Patent Application Publication
(10) Pub. No.: US 2010/0163372 A1
(43) Pub. Date: Jul. 1, 2010

(54) WORKPIECE CARRIER DEVICE

(75) Inventors: Matthias KRUPS, Konigswinter (DE); Peter Krups, Anhausen (DE)

Correspondence Address: Clements Bernard PLLC, 1901 Roxborough Road, Suite 250, Charlotte, NC, 28211, US

(73) Assignee: Ceratis GmbH, Dernbach (DE)

(21) Appl. No.: 12/640,813

(22) Filed: Dec. 17, 2009

Related U.S. Application Data
(60) Provisional application No. 61/145,302, filed on Jan. 16, 2009.

(30) Foreign Application Priority Data
Dec. 18, 2008 (DE) 10 2008 062 357.1

(51) Int. Cl. B65G 17/18

(52) U.S. Cl. 198/802

(57) ABSTRACT

A workpiece carrier device intended to be placed loosely on friction conveyors comprises a motion element. The motion element has a friction surface contacting a friction conveyor for the transfer of movement by means of friction forces. The motion element is connected with a carrier element through a connecting element. The connecting element further comprises a pressing element which exerts a contact pressure force from the carrier element on the motion element in the direction of the friction conveyor when the motion element is moved in the direction of transport.

### BACKGROUND OF THE INVENTION

1. Field of the Invention

The invention relates to a workpiece carrier device placed loosely in particular on a friction conveyor, such as a roller conveyor, a belt conveyor or a plate conveyor.

2. Description of Related Art

Particularly in mass production, conveyor means are used to transport workpieces between individual workplaces where the workpieces are assembled or processed, for example. To do so, the workpieces are placed on a workpiece carrier devices and the workpiece carrier device is moved together with the workpieces by corresponding conveyor means. Friction conveyors are known for displacing the workpiece carrier device. With friction conveyors, the workpiece carrier devices are not rigidly connected with the conveyor means, but may rest loosely on rollers, for example. The displacement of the workpiece carrier device is effected through friction forces occurring between the rollers, belts or plates and friction surfaces of the workpiece carrier device. It is a particular advantage of friction conveyors that they allow for a back-up of the workpiece carrier devices. Here, during the back-up process, the corresponding drive means of the friction conveyors slip. Friction conveyors require no intricate and complicated unlatching from a conveyor means, such as a chain. Another advantage of friction conveyors is that curves and especially branches can be realized in a simple manner. Using branching means, such as points, individual workpiece carrier devices may be discharged or introduced, for example. Thus, friction conveyors have a great flexibility. Such a friction conveyor is described in DE 40 36 214.

If the workpieces are heavy workpieces, particularly weighing over 100 kg, and/or workpieces of large dimensions, friction conveyors have the drawback that unfavourable friction conditions occur especially in the area of curves and branches. The friction conditions occurring when workpiece carriers back up are disadvantageous as well. Another drawback of friction conveyors for large workpieces is that the conveyor paths have to be made very wide. This increases the costs of such friction conveyors.

A friction conveyor particularly suited for transporting heavy workpieces is known from DE 10 2006 045 575. The workpiece carrier device comprises a motion element, especially of plate-shaped structure, with a friction surface that rests on the friction conveyor. A carrier element is preferably rigidly connected with the motion element, which motion element is plate-shaped, in particular. Preferably, the carrier element is also plate-shaped and serves to receive one or, if need be, a plurality of workpieces. The carrier element is connected with support elements. The support elements absorb a substantial part of the weight of the workpiece. The weight of the workpiece thus acts only partly, if at all, on the motion element. The support elements, such as wheels, connected with the carrier element transfer the weight force onto an absorption element which may be a part of the friction conveyor, for example, but which preferably is not connected with the drive elements of the friction conveyor. Providing additional support elements in order to not transfer at least a part of the workpiece weight onto the motion element has the advantage that the friction conditions occurring between the friction surface of the motion element and the drive elements of the friction conveyor are not adversely influenced.

Due to the separation of the workpiece carrier means into a motion element and a carrier element, it is possible to give them different sizes. This allows for the connection of a rather small motion element with a rather large carrier element suited to receive workpieces of large dimensions. In particular, it is possible to provide a modular system wherein identical motion elements are connected with different carrier elements, in particular carrier elements of different outer dimensions.

The friction conveyor described in DE 10 2006 045 575 is driven by means of rollers, for example, which abut a friction surface of the motion element. When the workpiece carrier is stopped at a treatment station or when the workpiece carriers back up, it is necessary to interrupt the transmission of force from the rollers to the motion elements. This is achieved by providing the driven rollers with friction clutches. The friction clutches have to be adjusted precisely depending on the back-up pressure. Further, regular readjustment and maintenance of the friction clutches are required. Moreover, friction clutches are expensive components.

### SUMMARY OF THE INVENTION

It is an object of the invention to provide a workpiece carrier device allowing for a simpler configuration of a friction conveyor.

In particular, the workpiece carrier device of the invention intended to loosely rest on friction conveyors is a development of the workpiece carrier device described in DE 10 2006 045 575 and preferably has the same essential features. The workpiece carrier device of the present invention especially comprises a motion element which, in particular, is of plate-shaped design. A friction surface of the motion element abuts against the friction conveyor to transmit the movement through friction forces. Here, the friction conveyor may comprise driven rollers or belts. The motion element is connected with a carrier element for receiving a workpiece, which carrier element is also in particular of a plate-shaped design. The carrier element especially serves to absorb the major part of the weight of the workpiece and preferably comprises a plurality of independent support elements in the form of wheels, for example.

The motion element is connected with the carrier element through at least one, in particular two connecting elements which, in particular, are configured as webs or columns. The connecting element comprises a pressing element especially for a loose or releasable connection of the motion element with the carrier element. The pressing element is configured such that, upon a displacement of the motion element in the transport direction, a contact pressure force acting in the direction of the friction conveyor, i.e. downwards. According to the invention, the provision of a pressing element thus causes the generation of contact pressure or a contact pressure force of the friction surface of the motion element on the friction conveyor. This is effected in particular by the fact that, in an approaching situation, the friction conveyor first moves the motion element slightly in the transport direction. Thereby, the pressing element provided between the motion element and the carrier element is activated, the contact pressure force substantially being exerted by the weight of the carrier element and the workpiece possibly situated on the carrier element.

In a back-up situation, it is preferably possible to deactivate the pressing element so that no or only a little contact pressure force is exerted on the friction conveyor. As a result, the friction clutches of the rollers of the friction conveyor may possibly be omitted, since the load relief of the motion element provided by the invention allows the rollers to slip on the friction surface of the motion element in a back-up situation. Due to the low weight of the motion element, no high wear occurs.

Preferably, the pressing element has a pressing surface oriented at an angle with respect to the transport direction, the pressing surface preferably being arranged at the carrier element and the carrier element being provided with a recess. Preferably, the angle of the pressing element, which preferably is oriented trans-verse to the transport direction or transverse to the carrier element, is smaller than 90°. In particular, the pressing surface is oriented under an angle of 30° to 60° relative to the transport direction, i.e. usually the horizontal. In a preferred embodiment, a contact element of the pressing element abuts against the pressing surface. If the pressing surface is provided at the carrier element, the contact element is provided at the motion element, where the contact element, in its simplest form, may merely be a possibly rounded end of the web- or column-like connecting element.

When the motion element is moved by the friction conveyor, the contact element contacts the pressing surface. Due to the pressing surface being inclined in the transport direction, the contact element slides slightly downward or towards the friction conveyor. This increases the contact pressure on the friction conveyor. The magnitude of the contact pressure substantially depends on the weight of the carrier element, as well as that of the workpiece arranged on the carrier element. As a consequence, high contact pressures are achievable with heavy workpieces.

In a back-up situation, the pressing element is deactivated for example by stopping the motion element simultaneously with the carrier element. As a result, the pressing element becomes spaced slightly from the pressing surface so that the workpiece and the carrier element no longer exert pressure on the motion element via the pressing surface. Thus, the contact pressure force is reduced substantially and ideally only corresponds to the weight force of the motion element. It is thus possible, for example in back-up situations, to allow the driven rollers of the friction conveyor to slip on the friction surface.

In a particularly preferred embodiment of the present workpiece carrier device, the pressing element has a second pressing surface opposite the first pressing surface. Thus, seen in the transport direction, the second pressing surface is preferably situated behind the first pressing surface, the inclination of the second pressing surface preferably being oriented opposite to that of the first pressing surface. Here, the angle of the second pressing surface is preferably identical to that of the first pressing surface. In particular in special transporting situations, the second pressing surface allows to exert a contact pressure force on the motion element in the direction of the friction conveyor, possibly via the contact element. This is of importance in negotiating bends, for example. Due to the separation of the carrier element and the motion element, it is possible—especially when travelling through bends—that the carrier element together with the workpiece situated thereon has a higher velocity than the motion element. If no second pressing surface were provided, the carrier element would move, for example coast, until the motion element catches up with it and the contact element again abuts against the first pressing surface. This would cause a jerking movement of the carrier element. The horizontal distance between the two pressing surfaces is slightly larger than the extension of the contact element in this direction so that, from the disengagement of the contact element from the first pressing surface to the abutment of the contact element against the second pressing surface, only a short distance of preferably a few millimetres must be traveled. Thereby, it is possible to achieve a substantially smooth travel of the carrier element also in bends.

It is particularly preferred to give the first and/or the second pressing surface a concave shape. Especially, the first and/or the second pressing surface is formed as a part of a sphere or of a cone. This is advantageous in particular when negotiating bends since jamming is avoided thereby. Further, the offset between the motion element and the carrier element occurring when bends are traveled through, causes the pressure on the motion element to be increased via the pressing element.

In another preferred embodiment, the contact element of the pressing element is designed such that it has a convex surface. In particular, the contact element is shaped as a sphere or a part of a sphere and thus preferably has a surface in the shape of a part of a sphere, a sphere, a part of a cone or a cone.

In a preferred embodiment, the connection of the carrier element with the motion element is done exclusively through the pressing element, the connection being effected exclusively by frictional engagement. This is advantageous in that the carrier element can be removed from the transport path, e.g. for maintenance purposes, with the motion element remaining on the friction conveyor. Thus, it is not necessary to remove covers of the friction conveyor, for example, in order to take the motion element from the friction conveyor. This has the advantage that at least large areas of the friction conveyor can be covered and that merely a slot has to be provided through which the preferably two column-shaped connecting elements protrude.

In a particularly preferred embodiment of the present workpiece carrier device, an actuator element is provided for displacing the motion element with respect to the carrier element particularly in a horizontal direction. The actuator element allows for the displacement of the motion element for example from a transport position, in which the contact element abuts against the first pressing surface, to a neutral position, in which no contact pressure force is transmitted from the pressing element to the actuator element. In this position, the contact element contacts neither the first nor the second pressing surface.

Preferably, the especially rod-shaped actuator element is connected with an approaching element. For example in a back-up situation of the workpiece carrier device, the approaching element actuates the actuator element. Moreover, the approaching element may serve to actuate the actuator element at a treatment station. The approaching element, which is in particular securely connected with the actuator element, may be arranged in the manner of a bumper at the front side of the workpiece carrier device, seen in the conveying direction.

In a particularly preferred embodiment, the actuator element is configured such that, as described above in the context of different preferred embodiments, not only will the force transmission from the carrier element to the pressing element be interrupted or reduced during the transition to the neutral position, but at the same time the friction forces between the motion element and the conveyor element, such as the friction conveyor, will be reduced. This is achieved preferably by lifting the motion element in the neutral position. To this end, in a preferred embodiment, the connecting element of the actuator element and/or the connecting element of the pressing element have a lifting element. The lifting element preferably is a surface inclined relative to the horizontal. For example, the connecting element of the actuator element has a surface inclined downward in the travelling direction, against which a pin or projection of the motion element abuts when the actuator element is actuated for a transfer to the neutral position. Thereby, the pin or projection slides on the inclined surface of the lifting element so that the motion element is lifted. In particular, the especially cylindrical or spherical contact element of the pressing element abuts against the inclined surface of the lifting element. Thus, in the movement position, the contact element abuts against a pressing surface and, in the neutral position, abuts against an inclined surface of the lifting element. Thus, the contact element has a double function.

In the preferred embodiment in which the actuator element is lifted, the conveyor means used may not only be friction conveyors, but also other conveyors such as chain conveyors and the like. Instead of a frictionally transmitted force for moving the carrier element, it is also possible to provide a positive connection. Here, the positive fit is cancelled by the motion element being lifted.

In a particularly preferred embodiment, at least one support element is connected with the carrier element of the workpiece carrier device that serves to receive especially heavy workpieces. In particular, the support elements, of which preferably a plurality is provided, are rollers. In a particularly preferred embodiment, the workpiece carrier device is developed preferably as described in DE 10 2006 045 575.

### BRIEF DESCRIPTION OF THE DRAWINGS

The following is a detailed description of embodiments of the present invention with reference to the accompanying drawings.

In the Figures:

FIG. 1 is a schematic bottom view of a preferred embodiment of the workpiece carrier device,

FIG. 2 is a schematic side view of a preferred embodiment of the workpiece carrier device in the direction of the arrow II in FIG. 1,

FIG. 3 is a schematic sectional view of a friction conveyor particularly suited for moving workpiece carrier devices of FIG. 1 or 2,

FIG. 4 is a schematic sectional view along line IV-IV in FIG. 1 with the workpiece carrier device being illustrated in the neutral or stop position,

FIG. 5 is a schematic sectional view along line IV-IV in FIG. 1 with the workpiece carrier device being illustrated in the movement position,

FIGS. 6 and 7 are schematic sectional views of a further preferred embodiment of the workpiece carrier device, and

FIGS. 8 and 9 are schematic sectional views of another preferred embodiment of the workpiece carrier device.

### DETAILED DESCRIPTION OF PREFERRED EMBODIMENTS

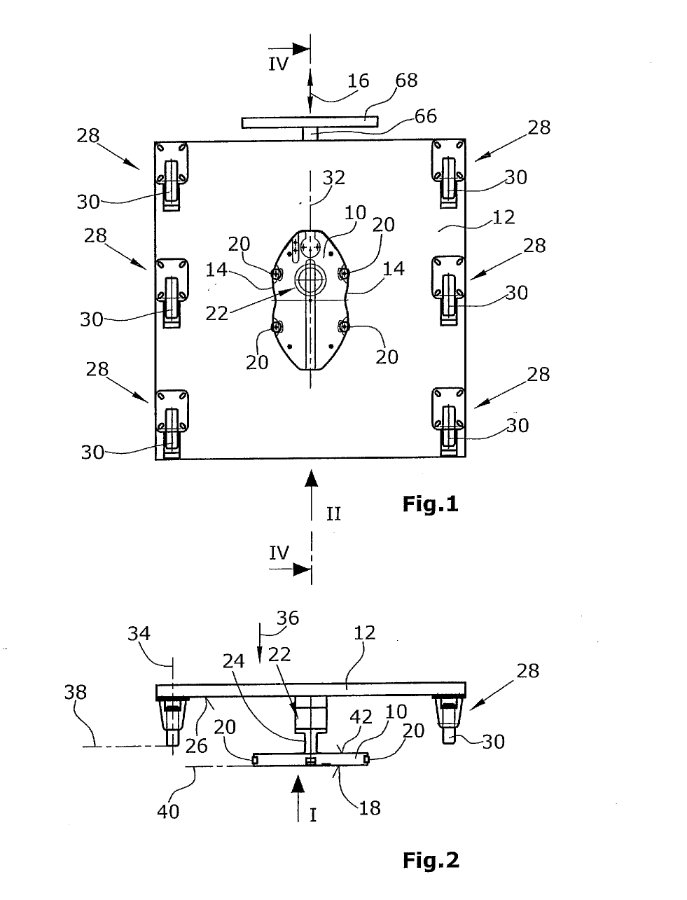

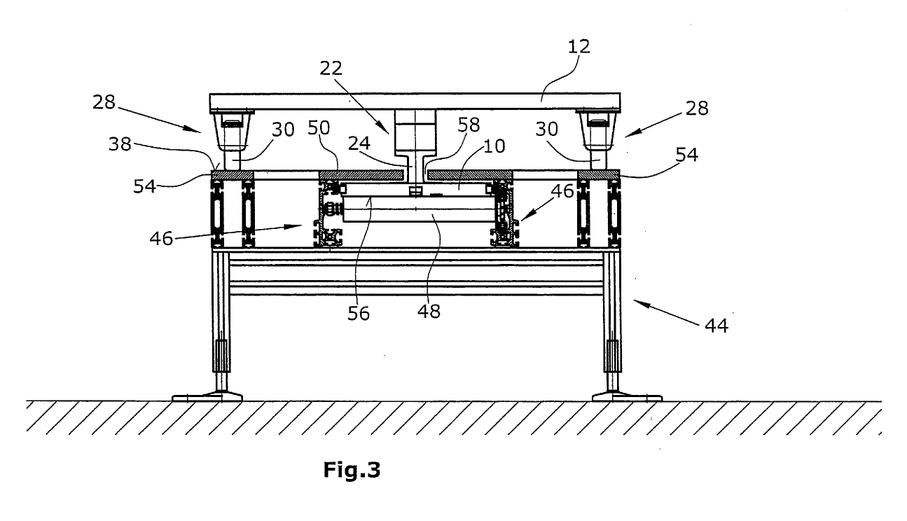

The preferred embodiment of the workpiece carrier device of the present invention, illustrated in FIGS. 1 and 2, comprises a motion element 10, as well as a carrier element 12. The motion element 10 has a substantially oval outer contour with an arc-shaped indentation 14 on two opposite sides. The indentations 14 are provided laterally with respect to the transport direction 16. This facilitates the movement of the motion element around bends or at branches. The motion element 10 has a planar bottom surface 18 designed as a friction surface. When the workpiece carrier device is used in combination with a roller conveyor, the drive rollers 48 (FIG. 3) contact the friction surface 18. Rollers 20 or similar sliding elements may be provided at the outer sides of the motion element 10, in particular to reduce friction in bends or the like.

The motion element 10 is connected with the carrier element 12 through a connecting element 22. The connecting element 22 is preferably of web-like configuration and has a taper at the end directed towards the motion element, so that the connecting element 22 is formed as a circular cylindrical web 24 in this region. In the portion of the connecting element 22 formed above the cylindrical web 24, a joint may be provided for an articulated connection of the motion element 10 with the carrier element 12.

In the embodiment illustrated, the bottom surface 26 of the especially plate-shaped carrier element 12 is provided with six support elements 28, each comprising a support roller 30. The six support elements 28 are arranged symmetrically with respect to a centre line 32 of the carrier element 12. In the embodiment illustrated, also the connecting element 22 is arranged symmetrically with respect to the centre line 32. The individual support rollers 30 are each pivotable about a pivot axis 34 so that the workpiece carrier device of the invention can be guided through curves in a simple manner.

A support plane 38 extends perpendicular to a weight force acting in the direction of the arrow 36, which corresponds to the direction of support in the embodiment illustrated. The support plane 38 is the plane in which, in the embodiment illustrated, all six support points or support regions of the rollers 30 are situated. At a horizontal distance from the support plane 38, the motion element plane 40 is provided in which in particular the friction surface 18 is situated. A top surface 42 of the motion element 10 is also preferably spaced from the support plane 40. As explained below, this is practical for the provision of a cover element 50 (FIG. 3). The web- or column-shaped part 24 of the connecting element 22 is arranged in a slot of the cover element 50.

With reference to FIG. 3, a roller conveyor will be described below, which is suitable for moving the workpiece carrier device illustrated in FIGS. 1 and 2. Frame-shaped carrier elements 46 are arranged on a base 44 that is in particular vertically adjustable. The carrier elements 46 carry a plurality of rollers arranged in succession in the direction of transport 16 and serving as drive elements 48. The surface of the rollers 48 contacts the friction surface 18 of the motion element 10. Due to the friction occurring between the drive rollers 48 and the friction surface 18, the motion element 10 is displaced and thereby the carrier element 12 connected with the motion element 10 through the connecting element 22 is also displaced in the direction of movement or transport 16. The rollers 48 are driven by gears, for example, or another drive means not illustrated. A cover element 50 is provided above the drive rollers 48.

The cover element 50 defines a space of substantially rectangular section, in which the motion element 10 is arranged. The motion element 10 is thus arranged between the drive elements 48 and the cover element 50. The cover element 50 serves to reduce contamination of the drive elements 48.

The cover element 50 has a slot extending in the direction of transport 16 (perpendicular to the plane of drawing in FIG. 3), in which the cylindrical part 24 of the connecting element 22 is arranged.

In the embodiment illustrated, a respective support element 54 is provided on both sides of the drive elements 48 at the same level as the cover element 50. The support rollers 30 roll on the planar support element 54 configured as a rolling track.

In order to be able to move the workpiece carrier device described with reference to FIGS. 1 and 2 by means of the friction conveyor illustrated in FIG. 3, a horizontal space is provided between a drive plane and a support plane. The support plane 38 corresponds to the top surface of the absorption elements 54. The drive plane corresponds to the top surface 56 of the drive elements 48 and coincides with the friction plane 18 of the motion element 10.

In the region of a branch, it is necessary that the web-shaped absorption elements pass into a enlarged surface. Since the support elements 28 provided on the bottom surface of the carrier element 12 have steering rollers freely pivotable around their pivot axis 34, the position of the rollers automatically follows the movement of the carrier element 12. When the carrier element 12 negotiates a bend, the outer rollers 30 must roll over the slot that extends straight on. This is possible without any difficulty, since the diameter of the rollers is considerably larger than the width of the slot.

The motion element 10 is releasably connected by means of a pressing element 60. In the embodiment illustrated, the pressing element comprises a first pressing surface 64 and a second pressing surface 72. The first pressing surface 64 is inclined in the direction of transport 16. The second pressing surface 72 is inclined in the opposite direction and is located opposite the first pressing surface 64. Both pressing surfaces 64, 72 extend transverse to the direction of transport 16 or transverse to the carrier element 12. Further, the pressing element has a contact element 76 connected with the connecting element 22. In the embodiment illustrated, the contact element 76 is a roller that is rotatable around a transverse axis 78 connected with the connecting element 22.

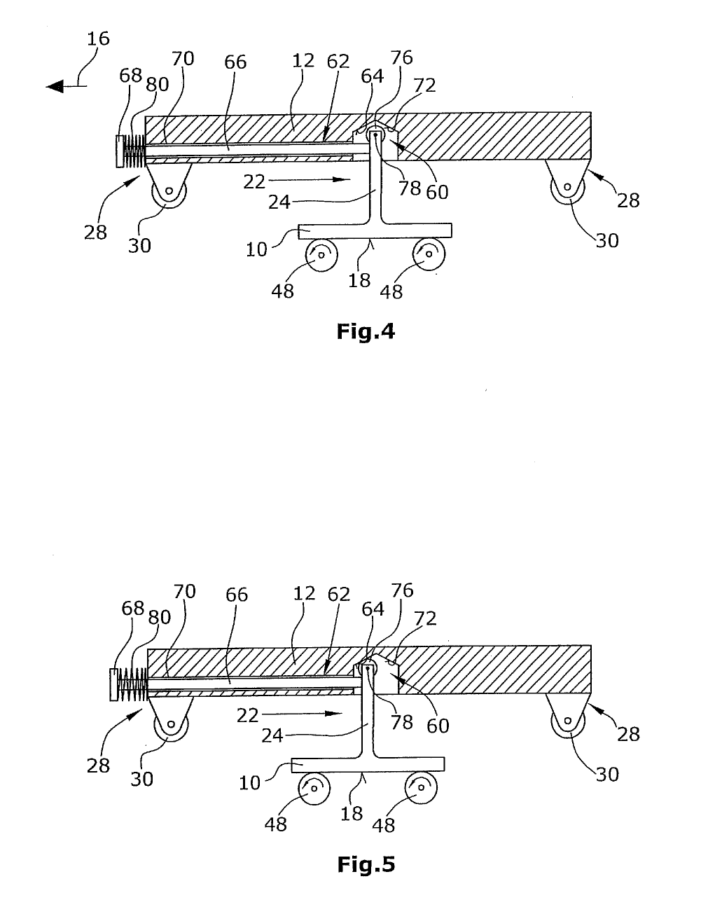

From the neutral or stop position illustrated in FIG. 4, the motion element 10 is moved in the direction of transport 16, i.e. to the left in FIG. 4, for example upon approaching, i.e. a rotation of the rollers 48 (counter-clockwise in FIG. 4). Thus, the contact element 76 abuts against the first pressing surface 64. Because of the weight of the carrier element 12 as well as of the workpiece located on the carrier element, a pressure force is exerted that is directed downward towards the friction conveyor 48 in FIG. 4. Thus, in a simple manner, it is possible to move the carrier element 12 exclusively by means of a friction engagement of the motion element 10 and the carrier element 12 that is caused by the pressing elements 64, 72.

For example, when travelling through a bend, the velocity of the carrier element 12 may be higher than the velocity of the motion element 10. As a result, the contact element 76 no longer contacts the first pressing surface 64. Because of the opposite second pressing surface 72 a contact pressure force is again exerted on the motion element 10 so that an almost smooth movement of the carrier element 12 is possible also in bends. As soon as the velocity of the motion element 10 is higher again than that of the carrier element 12, the contact between the contact element 76 and the second pressing surface 72 is released again and the contact element 76 again contacts the first pressing surface 64.

A displacing means is provided to horizontally displace the motion element 10 from a movement position (FIG. 5) into a stop position (FIG. 4). In the embodiment illustrated, the displacement means comprises an actuator element 62. The actuator element 62 is provided with a rod-shaped connecting element 66 fixedly connected with an approaching element 68 similar to a bumper. The connecting element 66 is provided in an opening 70 of the carrier element 12, preferably in the form of a bore, and is guided therein for longitudinal displacement.

Moving the motion element 10 from the movement position (FIG. 5) to the stop position (FIG. 4) requires a displacement of the actuator element 62 in the direction of the arrow 74, i.e. to the right in FIG. 5. For example, this is achieved by the approaching element 68 bumping against a stopper at a treatment station or bumping into a workpiece carrier device moving ahead thereof in the direction of transport. Thereby, the actuator element 62 is displaced to the position illustrated in FIG. 4. The horizontal displacement of the motion element 10 relative to the carrier element 12 shifts the contact element 76 to a position in which it contacts neither of the two pressing surfaces 64, 72. Thus, the carrier element 12 and the workpiece possibly located on the carrier element 12 transmit no force onto the motion element 10. As a consequence, the rollers 48 slip on the friction surface 18, for example. Because of the low friction force present, no heavy wear of the friction surface 18 or the surface of the rollers 48 occurs.

To return the motion element 10 from the neutral or stop position (FIG. 4) back to the movement position (FIG. 5), the actuator element 62 has to be released. This is achieved, for example, by retracting the stopper at a treatment station or by resolving the back-up situation. Thereby, the actuator element 62 returns to the position illustrated in FIG. 4, the movement of the actuator element 62 possibly being assisted by a spring 80 provided between the approaching element 68 and the carrier element 12.

In the embodiment illustrated in FIGS. 4 and 5, an actuator element corresponding to the actuator element 62 may also be provided on the right in FIGS. 4 and 5 or the rear of the workpiece carrier device. Thus, the workpiece carrier device can be moved in both directions.

Since the first workpiece carrier or the first actuator element of the workpiece carrier bumps against a stationary stopper, even the bumping in of another workpiece carrier does not cause a pushing back of the actuator element so that the workpiece carriers may each comprise an especially bumper-like actuator element at the front and the rear.

Further, it is also possible to arrange the bumpers at the front and the rear of the workpiece carriers at different heights, so that, in a back-up situation, a workpiece carrier does not bump against the approaching element 68 of the workpiece carrier ahead, but rather bumps against the base body of the same, for example.

Another possibility is to provide separately acting bumpers at the front and the rear of a workpiece carrier.

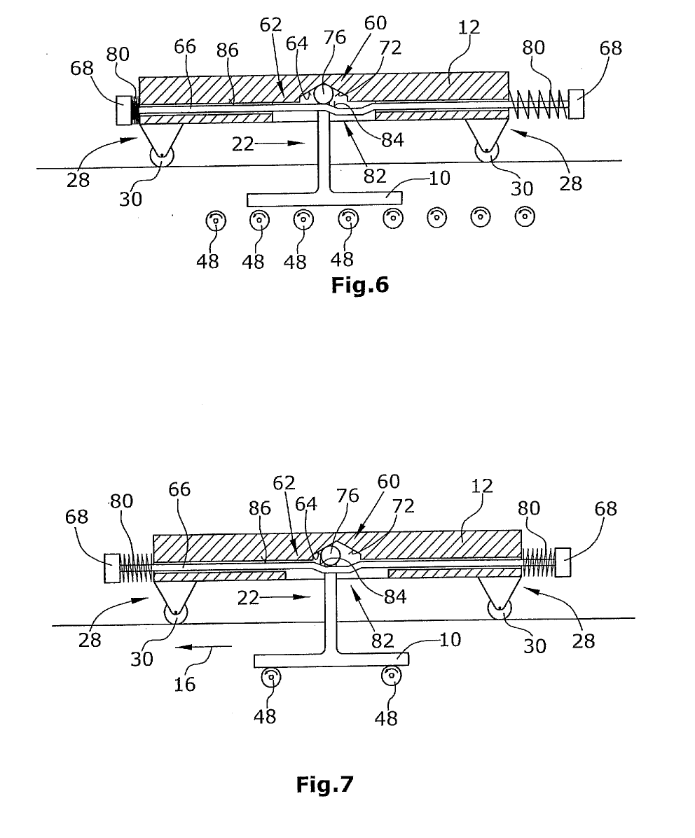

In another preferred embodiment (FIGS. 6 and 7) identical or similar parts are identified by the same reference numerals.

The essential difference of this embodiment is that the connecting element 66 of the actuator element 62 is not fixedly connected with the connecting element or web 22 of the motion element 10. Rather, the connecting element 66 has a bevel acting as a lifting element 82 provided in the vicinity of the pressing element 62. In the embodiment illustrated, the lifting element 82 is formed integral with the connecting element 66 and has a surface 84 that is oblique or inclined with respect to the horizontal.

From a movement position (FIG. 7), in which the workpiece carrier 12 is trans-ported in the direction of the arrow 16, the contact element 76 of the pressing element 60 reaches a disengaged or neutral position due to the movement of the approaching element 68 and the connecting element 66 connected therewith.

The contact element 76, which in the movement position abuts against the pressing surface 64, would thus initially be disengaged from the surface 64 since the inclined surface 84 of the lifting element 82 presses against the contact element 76 and shifts the same to the right in FIG. 7 or stops it and the conveyor element 48 moves a little further to the left in FIG. 7. The contact element 76 now slides along the inclined surface 84. Since the same rises, the contact element 76 is lifted until it rests on a surface 86 of the connecting element 66 (FIG. 6), the surface 86 being a horizontal surface in this embodiment. In this position, the contact element 76 may also rest on the pressing surfaces 64, 72 again, since the connecting element 22 is spaced from the drive rollers 48 and thus no drive force can be transmitted to the carrier element 12.

As soon as a back-up situation is resolved, the spring 80 returns the actuator element 62 to the position illustrated in FIG. 7, as described in the context of the previous embodiment (FIGS. 4, 5), so that the contact element 76 again contacts the surface 64 and a force transmission from the rollers 48 to the carrier element 12 occurs again via the motion element 10 and the surface 64.

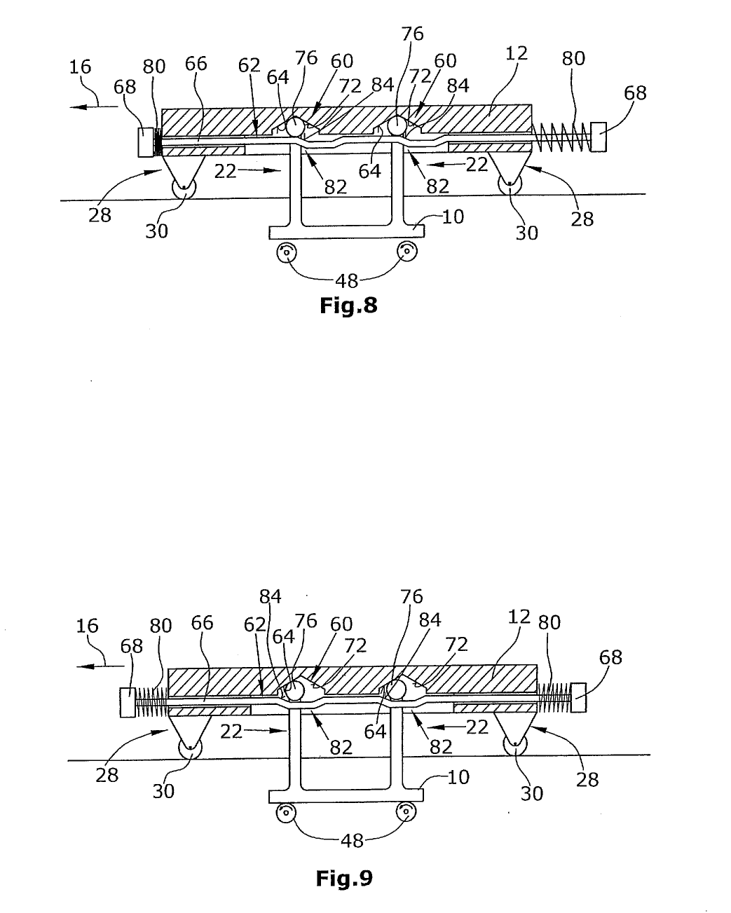

The further preferred embodiment illustrated in FIGS. 8 and 9 essentially corresponds to the embodiment shown in FIGS. 6 and 7 so that similar and identical parts are identified by the same reference numerals.

The essential difference is that the motion element 10 is not only connected with one connecting element, but with two connecting elements 22. Accordingly, two pressing elements 60 and two lifting elements 82 are provided. These are actuated through the common actuator element 62 and moved from the movement position (FIG. 9) to the neutral position (FIG. 8), for example.

Of course, it is possible to also provide the embodiment illustrated in FIGS. 4 and 5 with two connecting elements 22 arranged one behind the other in the direction of travel 16 or side by side.

Although the invention has been described and illustrated with reference to specific embodiments thereof, it is not intended that the invention be limited to those illustrative embodiments. Those skilled in that art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A workpiece carrier device intended to be placed loosely on friction conveyors, comprising
a motion element having a friction surface contacting a friction conveyor for the transfer of movement by means of friction forces, and
a carrier element for receiving a workpiece, said element being connected with the motion element through a connecting element,
wherein
the connecting element comprises a pressing element which is configured such that, due to the weight of the carrier element and/or of the workpiece arranged on the carrier element, it exerts a contact pressure force from the carrier element on the motion element in the direction of the friction conveyor when the motion element is moved in the direction of transport.

2. The workpiece carrier device of claim 1, wherein the pressing element has a pressing surface arranged under an angle with respect to the direction of transport, said surface preferably being provided on the carrier element.

3. The workpiece carrier device of claim 1, wherein the pressing element has a second pressing surface that is situated opposite the first pressing surface in the direction of transport.

4. The workpiece carrier device of claim 2, wherein the pressing element comprises a contact element preferably rotatable around a transverse axis, said contact element resting on the first and/or second pressing surface when the carrier element is moved.

5. The workpiece carrier device of claim 2, wherein the first pressing surface and/or the second pressing surface are concave in shape.

6. The workpiece carrier device of claim 4, wherein the contact element has a convex surface, which is in particular shaped as a part of a sphere, a sphere, a part of a cone or a cone.

7. The workpiece carrier device of claim 1, wherein the connection between the carrier element and the motion element via the pressing element is effected exclusively by friction engagement.

8. The workpiece carrier device of claim 1, wherein the pressing element has a neutral position, in which no contact pressure force is exerted, and a movement position, in which contact pressure force is transmitted.

9. The workpiece carrier device of claim 8, wherein an actuator element connected with the pressing element is provided for moving the pressing element to a neutral and/or a movement position.

10. The workpiece carrier device of claim 9, wherein the actuator element an approaching element arranged in particular in front of the carrier element, seen in the direction of transport of the workpiece carrier device.

11. The workpiece carrier device of claim 10, wherein the approaching element is connected with an especially rod-shaped connecting element preferably provided substantially within the carrier element.

12. The workpiece carrier device of claim 9, wherein, in the neutral position, the motion element is lifted preferably by the actuator element so as to reduce friction forces.

13. The workpiece carrier device of claim 12, wherein the actuator element comprises in particular the connecting element of the actuator element and/or the pressing element comprises a lifting element.

14. The workpiece carrier device of claim 13, wherein the lifting element has a surface provided at the actuator element or the pressing element, which surface is inclined with respect to a horizontal, so that a preferably horizontal displacement of the actuator element causes a preferably vertical lifting of the motion element.

15. The workpiece carrier device of claim 14, wherein, during the displacement of the pressing element to the neutral position, the contact element of the pressing element contacts said inclined surface.

16. The workpiece carrier device of claim 1, wherein the carrier element is connected with at least one support element independent of the actuator element, which support element is provided for absorbing at least a part of the weight of the workpiece, the support element preferably being arranged at a bottom surface of the carrier element.
